(19) United States
(12) Patent Application Publication
(10) Pub. No.: US 2005/0269545 A1
(43) Pub. Date: Dec. 8, 2005

(54) Eccentric type rotary valve

(76) Inventors: Yasuhiro Chiba, Miyagi (JP); Yoichi Kanno, Miyagi (JP); Satoshi Mizogami, Miyagi (JP)

Correspondence Address: YOUNG & THOMPSON, 745 SOUTH 23RD STREET, 2ND FLOOR, ARLINGTON, VA, 22202, US

(21) Appl. No.: 11/116,351

(22) Filed: Apr. 28, 2005

(30) Foreign Application Priority Data
Apr. 28, 2004 (JP) 2004-134467

(51) Int. Cl. F16K 5/00

(52) U.S. Cl. 251/315.07

(57) ABSTRACT

Valve capacity Cv value is increased and valve performance is further improved. A valve body 11 has a valve chamber 19 and a flow passage 20 passing through this valve chamber 19 inside. A valve shaft 12 is extended in the direction crossing the flow passage 20 and penetrates the valve body 11. One end of the valve shaft 12 is arranged in the valve chamber 19. A valve seat 13 with a valve hole is provided in the inlet of the valve chamber of the flow passage 20. A valve plug 15 is mounted to one end of the valve shaft 12 in the cantilever state. The valve plug 15 is provided in the valve chamber 19 capable of opening/closing the valve hole by the rotation of the valve shaft 12. The valve seat 13 is provided in the valve body 11 through a bellows 40.

### TECHNICAL FIELD OF THE INVENTION

The present invention relates to an eccentric type rotary valve for fluid control.

### BACKGROUND ART

[Patent Document 1] Japanese Unexamined Utility Model Publication No. 57-147467

[Patent Document 2] Japanese Unexamined Patent Publication No. 11-118044

As a conventional eccentric type rotary valve, there is one shown in FIGS. 11 and 12 as well as the patent document 1, for example. That is, the eccentric type rotary valve shown in FIG. 11 has a valve body 1, a valve shaft 2, a valve seat 3, a retainer 4 and a valve plug 5, and the center part of the valve plug 5 is fixed to the valve shaft 2 by an arm part 6 so that the valve plug 5 opens/closes a flow passage of the valve seat 3 by rotation of the valve shaft 2. In the eccentric type rotary valve shown in FIG. 11, the valve shaft 2 crosses the flow passage 7 as shown in FIG. 5(B). The eccentric type rotary valve shown in the patent document 1 has construction that the valve shaft crosses the flow passage as that in FIG. 11. The eccentric type rotary valve shown in FIG. 12 has a valve body 1a, two valve shafts 2a, 2b, a valve seat 3a, a retainer 4a and a valve plug 5a, and the both ends of the valve plug 5a are fixed to the two valve shafts 2a, 2b in the center impeller state by arm parts 6a, 6b so that the valve shafts 2a, 2b do not cross a flow passage 7a and flow of fluid is not prevented as compared with the one in FIG. 11.

However, with the eccentric type rotary valve described in the patent document 1, even in the one with the valve shaft crossing the flow passage or the one with the valve plug mounted to the two valve shafts in the center impeller state, the valve shaft resists the fluid and lowers the flow rate. And a valve capacity Cv value can not be increased and the valve performance can not be improved, which constitutes a problem.

The technology described in the patent document 2 was made paying attention to the problem of the technology described in the patent document 1 and has an object to provide an eccentric type rotary valve which can increase the valve capacity Cv value and improve the valve performance.

That is, the patent document 2 discloses an eccentric type rotary valve having a valve body, a valve shaft, a valve seat and a valve plug; the valve body has a valve chamber inside and a flow passage passing through this valve chamber; the valve shaft extends in the direction crossing the flow passage and penetrates the wall surface of the valve body and its one end is arranged in the valve chamber; the valve seat has a vale hole and provided at an inlet or an outlet of the valve chamber of the flow passage; and the valve plug is mounted to one end of the valve shaft in the cantilever state and provided in the valve chamber capable of opening/closing the valve hole by rotation of the valve shaft.

However, a valve with more excellent valve performance than the valve described in the patent document 2 is in demand. Also, a valve which can be applied to various applications is in demand.

### DISCLOSURE OF THE INVENTION

### PROBLEM TO BE SOLVED BY THE INVENTION

The present invention has an object to provide an eccentric type rotary valve with more excellent valve performance such as flow rate control accuracy than before.

The present invention has an object to provide an eccentric type rotary valve which can be used for wider applications than before.

### MEANS FOR SOLVING THE PROBLEM

An eccentric type rotary valve of the present invention having a valve body, a valve shaft, a valve seat and a valve plug, in which the valve body has a valve chamber inside and a flow passage passing through this valve chamber, the valve shaft extends in the direction crossing the flow passage and penetrates the wall surface of the valve body and its one end is arranged in the valve chamber, the valve seat has a valve hole and is provided at an inlet or an outlet of the valve chamber of the flow passage, and the valve plug is mounted to one end of the valve shaft in the cantilever state and provided in the valve chamber capable of opening/closing the valve hole by rotation of the valve shaft, characterized in that:

the valve seat is provided through a bellows.

An eccentric type rotary valve of the present invention having a valve body, a valve shaft, a valve seat and a valve plug, in which the valve body has a valve chamber inside and a flow passage passing through this valve chamber, the valve shaft extends in the direction crossing the flow passage and penetrates the wall surface of the valve body and its one end is arranged in the valve chamber, the valve seat has a valve hole and is provided at an inlet or an outlet of the valve chamber of the flow passage, and the valve plug is mounted to one end of the valve shaft in the cantilever state and provided in the valve chamber capable of opening/closing the valve hole by rotation of the valve shaft, characterized in that:

a portion of the valve plug brought into contact with the valve seat is constituted by a resin.

An eccentric type rotary valve of the present invention having a valve body, a pair of valve shafts, a pair of valve seats and a valve plug provided at each of the valve shafts, characterized in that:

the valve body has a valve chamber inside and a plurality of flow passages communicating from this valve chamber to the outside;

each of the pair of valve shafts extends in the direction crossing this flow passage and penetrates the wall surface of the valve body, respectively and its one end is arranged in the valve chamber;

each of the pair of valve seats has a valve hole and is provided on the valve chamber side of the plurality of flow passages; and

the valve plug is mounted at one end of the valve shaft in the cantilever state and provided in the valve chamber capable of opening/closing the valve hole by rotation of the valve shaft.

It is preferable that the flow passage extends in the straight pipe state. The valve shaft extends in the direction perpendicular the flow passage and is decentered with respect to the valve hole of the valve seat. Therefore, when the valve plug closes the valve hole of the valve seat, an urging force to press the valve plug onto the valve seat acts so that shutoff performance can be improved.

In the eccentric type rotary valve according to the present invention, when the valve plug opens the valve hole, the fluid flows through inside the flow passage of the valve body. When the valve shaft is rotated to close the valve hole with the valve plug, flow of the fluid is stopped. If the valve shaft is rotated to open the valve hole, the fluid can flow again. The valve plug is mounted to one end of the valve shaft in the valve chamber and supported in the cantilever state. Therefore, when compared with the case where the valve shaft crosses the flow passage or the case where the valve plug is mounted on two valve shafts, the valve shaft can be constituted not to prevent flow of the fluid, by which the valve capacity Cv value can be increased and the flow rate can be increased.

It is preferable that the valve shaft and the valve plug are constituted integrally. Since the valve shaft and the valve plug are integrated, costs can be reduced by reduction in the number of components.

The valve body has a bonnet and a valve casing, and the bonnet has a wall surface through which the valve shaft penetrates and is provided capable of opening/closing the valve casing. When the bonnet is opened, it is preferable that the valve body opens an opening through which the valve plug can be replaced. Since the bonnet is opened to take out the valve plug from the opening of the valve body together with the valve shaft for replacement, switching of the valve plug is facilitated.

It is preferable that a valve-seat pressing member is provided, and the valve-seat pressing member is fixed to the valve body in the flow passage opposite to the valve chamber with the valve seat between them and has a through hole along the flow passage and an O-ring provided between the valve-seat pressing member in the flow passage and the valve seat. When the valve shaft is rotated to close the valve hole with the valve plug, upon contact of the valve plug with the valve seat, the valve seat compresses the O-ring between it and the valve-seat pressing member so as to increase adhesiveness between the valve plug and the valve seat so that the valve hole can be surely shut off. Also, by the O-ring, leakage of the fluid between the valve seat and the flow passage can be surely shut off.

It is preferable that the valve seat is arranged with a clearance from the internal surface of the flow passage so that its portion on the valve chamber side is capable of oscillation. When the valve plug closes the valve hole, the valve plug hits the valve seat and compresses the O-ring, and the valve seat follows movement of the valve plug and swings in the clearance in the flow passage so that the valve hole can be surely shut off. At this time, leakage of the fluid between the valve seat and the flow passage is shut off by the O-ring. The valve plug is supported in the cantilever state, and even if opening/closing operation of the valve plug lacks accuracy, the valve seat is moved following the movement of the valve plug so as to absorb slight movement of the valve plug, and the valve hole can be surely shut off.

It is preferable that the flow passage extends in the straight pipe state, while the valve shaft extends in the direction perpendicular to the flow passage, and the valve plug is arranged on one side on the plane passing through the center line of the flow passage when the valve hole is opened and in parallel with the valve shaft, and the valve chamber is formed with the other side narrower than the one side so that the flow rates of both sides of the plane become almost equal. When the valve plug opens the valve hole, the flow rate on one side where the valve plug is arranged on the plane passing through the center line of the flow passage and in parallel with the valve shaft is set almost equal to the flow rate on the other side. The valve chamber is formed asymmetrically with the other side narrower than the one side. Therefore, when compared with the case where the other side is formed symmetrically with the one side, expansion of the valve chamber can be made small, diffusion of the fluid can be prevented, and the fluid can be made to flow easily.

### EFFECT OF THE INVENTION

According to the eccentric type rotary valve of the present invention, since one end of the valve shaft is arranged in the valve chamber and the valve plug is mounted to one-end of the valve shaft in the cantilever state, when compared with the case where the valve shaft crosses the flow passage or the case where the valve plug is mounted to two valve shafts, the valve shaft does not prevent flow of the fluid, the valve capacity Cv value is increased and the valve performance can be improved. Since there is no obstruction in the middle, the fluid flows through the valve smoothly, a powder can be also used, and moreover, substitution of the fluid in the valve can be performed in a short time, which is optimum for use of super high-purity fluid, medicines or foods for which substitution time in the valve is critical.

Moreover, flow rate of the fluid can be controlled with higher accuracy.

### BRIEF DESCRIPTION OF THE DRAWINGS

FIG. 1 A longitudinal sectional view showing the basic construction of an eccentric type rotary valve of the present invention.

FIG. 2 A longitudinal sectional view showing the periphery of a valve seat of the eccentric type rotary valve in FIG. 1.

FIG. 3 A longitudinal sectional view showing flow of the fluid of the eccentric type rotary valve in FIG. 1.

FIG. 4 (A) A side view and (B) a plan view of a valve shaft and a valve plug of the eccentric type rotary valve in FIG. 1.

FIG. 5 (A) A view showing the arrangement relationship between the flow passage and the valve plug of the eccentric type rotary valve in FIG. 1 and (B) a view showing the arrangement relationship between the flow passage and the valve plug of a conventional eccentric type rotary valve.

FIG. 6 A graph showing the valve capacity Cv value to the valve opening degree of the eccentric type rotary valve in FIG. 1 in comparison with a globe valve with the same valve seat diameter.

FIG. 7 A graph showing the valve capacity Cv value to the valve angle of the eccentric type rotary valve in FIG. 1 in comparison with the conventional eccentric type rotary valve.

FIG. 8 A partial sectional view showing the eccentric type rotary valve according to a preferred embodiment 1 of the present invention.

FIG. 9 A partial sectional view showing the eccentric type rotary valve according to a preferred embodiment 2 of the present invention.

FIG. 10 A longitudinal sectional view showing the eccentric type rotary valve according to a preferred embodiment 3 of the present invention.

FIG. 11 A longitudinal sectional view showing the conventional eccentric type rotary valve.

FIG. 12 A longitudinal sectional view showing another conventional eccentric type rotary valve.

### EXPRESSION OF REFERENCE LETTERS

10 Eccentric type rotary valve
11 Valve body
12 Valve shaft
13 Valve seat
14 Valve-seat pressing member
15 Valve plug
15f Valve plug resin portion
16 O-ring
17 Bonnet
18 Valve casing
19 Valve chamber
20 Flow passage
40 Bellows

### BEST MODE FOR CARRYING-OUT OF THE INVENTION

(Basic Construction)

The basic construction of the present invention is the same as that described in the patent document 2. That will be described here again.

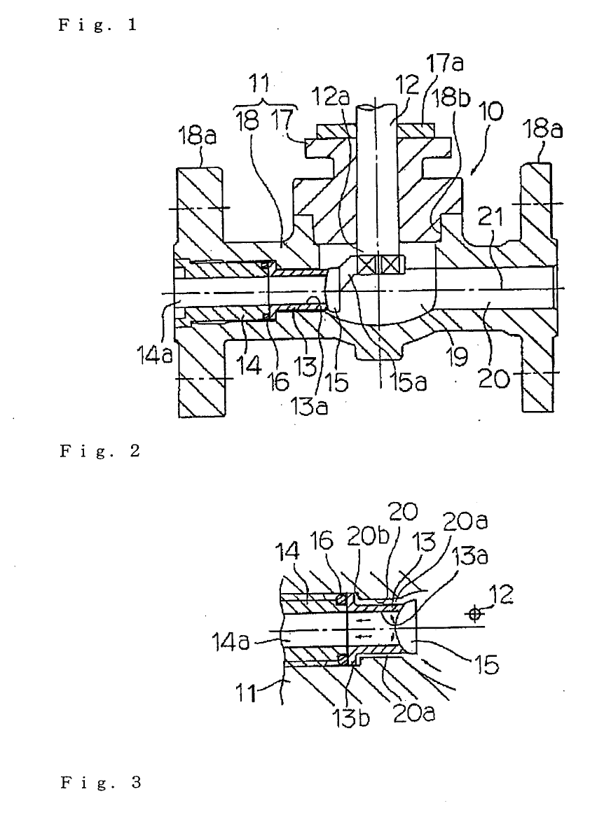

A preferred embodiment of the present invention will be described based on the drawings. FIGS. 1 to 7 show the preferred embodiment of the present invention. As shown in FIG. 1, the eccentric type rotary valve 10 has the valve body 11, the valve shaft (transmission shaft) 12, the valve seat (seat ring) 13, the valve-seat pressing member (retainer) 14, the valve plug 15 and the O-ring 16. The eccentric type rotary valve 10 is an eccentric plug type rotary valve in various types of flow-rate regulating valves and opening/closing valves in fluid control.

The valve body 11 has the bonnet 17 and the valve casing (body) 18. The bonnet 17 is provided capable of opening/closing with respect to the valve casing 18. A guide (bearing) 17a is fixed to the bonnet 17. The valve casing 18 has the valve chamber 19 inside and the flow passage 20 passing through this valve chamber 19. The flow passage 20 extends in the valve casing 18 in the straight pipe state. The valve casing 18 has a flange 18a for mounting at both ends. The valve shaft 12 extends in the direction perpendicular to the flow passage 20 and penetrates the bonnet 17 and the guide 17a. The valve shaft 12 can be rotated and manipulated outside the valve body 11. As shown in FIGS. 2 and 3, the valve shaft 12 (its center axis is shown in FIGS. 2 and 3) is decentered with respect to a valve hole 13a of the valve seat 13. By this, with the principle of leverage, the shutoff force when stopping the fluid can be increased. As for the valve shaft 12, one end 12a is arranged within the valve chamber 19. The one end 12a of the valve shaft 12 is arranged at a position not blocking the straight-pipe state flow passage 20 with the valve chamber 19 between them.

The valve seat 13 is provided at the valve-chamber inlet of the flow passage 20. The valve seat 13 forms the pipe state and has the valve hole 13a along the flow passage 20. The valve seat 13 is, as shown in FIG. 2, arranged with a clearance 20a from the inner surface of the flow passage 20 so that the valve-chamber side portion is capable of oscillation. The valve seat 13 has a flange 13b on the outer circumference opposite to the valve chamber 19. The flange 13b is engaged with an annular stepped part 20b provided inside the flow passage 20 to prevent drop-off of the valve seat 13 toward the valve chamber 19.

The valve-seat pressing member 14 is fixed to the valve chasing 18 in the flow passage 20 opposite to the valve chamber 19 with the valve seat 13 between them. The valve-seat pressing member 14 has a through hole 14a along the flow passage 20. The O-ring 16 is provided between the end of the valve-seat pressing member 14 in the flow passage 20 and the end of the valve seat 13. The O-ring 16 has elasticity and maintains sealing performance of the fluid between the valve-seat pressing member 14 and the valve seat 13. A gland packing may be used instead of the O-ring 16, and the range of application such as temperature range, used fluid, etc. is expanded if the sealing portions of the fluid is made in the metallic structure.

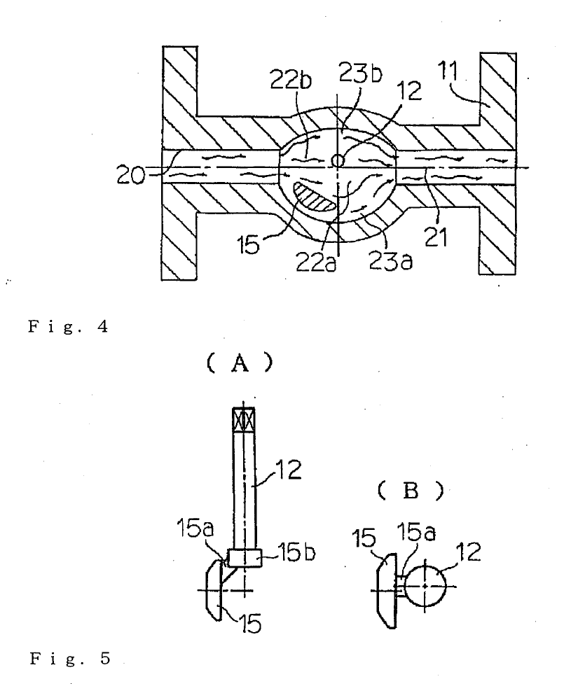

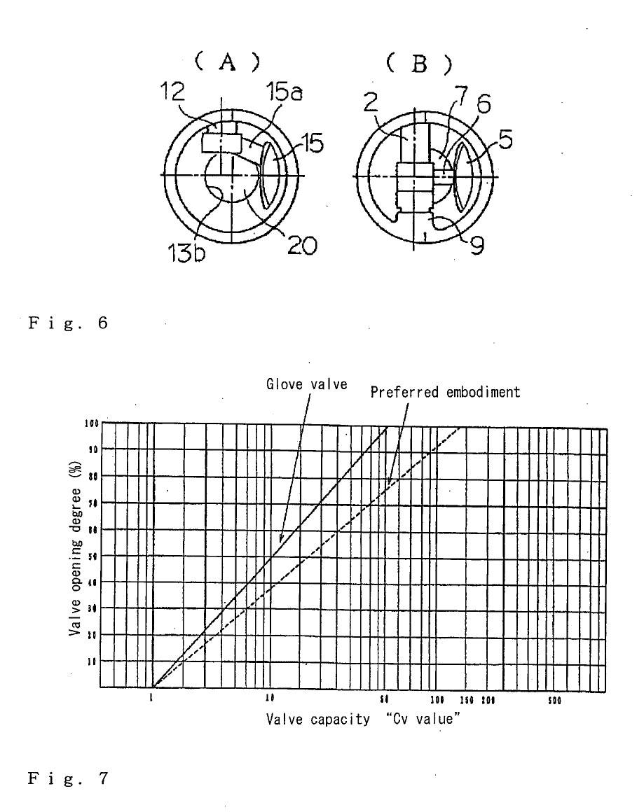

The valve plug 15 is mounted, as shown in FIG. 4, on the one end 12a of the valve shaft 12 by a cantilever arm 15a in the cantilever state. The valve shaft 12 has a rectangular chamfered or spline portion at a mounting point of the cantilever arm 15a, and the cantilever arm 15a is fixed to the valve shaft 12 with a bolt or a pin. The valve plug 15 is provided in the valve chamber 19 capable of opening/closing the valve hole 13a by rotation of the valve shaft 12.

The valve plug 15 may be integrated with the valve shaft 12 by applying friction welding of a base 15b to the valve shaft 12. By this, the number of components and production processes can be reduced and costs can be lowered. In this case, in the production process, it is not necessary to connect the valve plug to the valve shaft inside the valve casing as before, but easy assembling is possible only by mounting the valve plug 15 integrated with the valve shaft 12 to the bonnet 17 and join it to the valve casing 18.

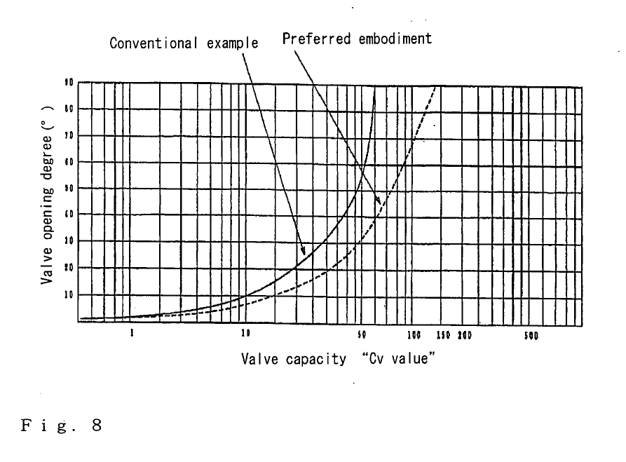

The valve plug 15 is arranged on one side 22a with respect to a plane 21 passing through the center line of the flow passage 20 when the valve hole 13a is opened and in parallel with the valve shaft 12. At this time, as shown in FIG. 5(A), the valve plug 15 is arranged at a position not blocking the straight-pipe state flow passage 20 with the valve chamber 19 between them. The valve chamber 19 is formed with the other side 22b narrower than the one side 22a so that flow rates on both sides of the plane 21 become almost equal. An opening 18b opened when the valve chasing 18 opens the bonnet 17 is sized to enable replacement of the valve plug 15.

Next, the action will be described. In the eccentric type rotary valve 10, when the valve plug 15 opens the valve hole 13a, the fluid, which is liquid or gas, for example, flows inside the flow passage 20 of the valve body 11. At this time, as shown in FIG. 3, the flow rates on the one side 22a on which the valve plug 15 is arranged with respect to the plane 21 passing through the center line of the flow passage 20 and in parallel with the valve shaft 12 and the other side 22b are set almost equal, and the valve chamber 19 is formed asymmetrically with the other side 22b narrower than the one side 22a.

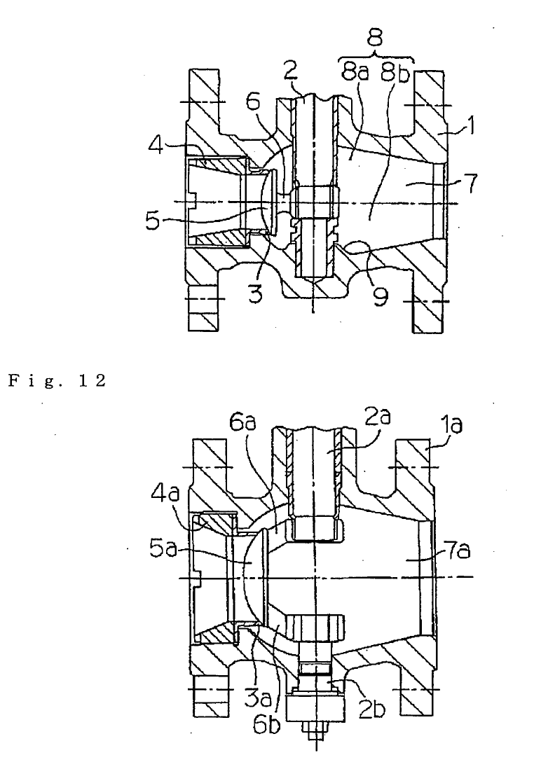

In the conventional eccentric type rotary valve, as shown in FIG. 11, the valve plug 5 is mounted on the valve shaft 2 for rotation in the valve casing so that the flow rate is controlled and regulated, and the other side 8b is formed symmetrically in correspondence with the one side 8a of a valve chamber 8 in which the valve plug is arranged. Therefore, the valve chamber 8 is wider than necessary in the conventional eccentric type rotary valve, and the fluid is diffused in the valve chamber 8 after passing through the valve hole, which was one of the factors that could not increase the valve capacity (flow rate coefficient) Cv value. On the other hand, in the eccentric type rotary valve 10, the other side 22b is narrower than the one side 22a where the valve plug 15 is arranged and the valve chamber 19 is asymmetrical. Thus, expansion of the valve chamber 19 can be made smaller than the conventional eccentric type rotary valve to prevent the fluid from being diffused so that the fluid can flow smoothly. Also, in the conventional eccentric type rotary valve shown in FIG. 11, a shaft core portion 9 is needed at the lower part of the valve chamber, while the shaft core portion is not necessary for the valve chamber 19 of the eccentric type rotary valve 10, and inclination of the valve chamber 19 is gentle.

In FIG. 3, flow of the fluid in the eccentric type rotary valve 10 is shown by an arrow. As the valve plug 15 when opened is stored in an inflated portion 23a of the one side 22a, the valve plug 15 exerts an effect to prevent diffusion of the fluid. Little fluid flows into an inflated portion 23b of the other side 22b, and the flow is almost straight in the other side 22b. In this way, the eccentric type rotary valve 10 prevents diffusion of the fluid and makes the fluid flow smoothly.

The eccentric type rotary valve 10 prevents flow of the fluid when the valve hole 13a is closed by the valve plug 15 by rotating the valve shaft 12, as shown in FIG. 1. Since the valve shaft 12 is eccentric against the valve hole 13a of the valve seat 13, an urging force to press the valve plug 15 onto the valve seat 13 acts by a wedge effect when the valve is closed so that the closing performance can be improved. Also, when the valve is closed, if the valve plug 15 hits the valve seat 13, the valve seat 13 compresses the O-ring 16 between it and the valve-seat pressing member 14 so that adhesiveness between the valve plug 15 and the valve seat 13 can be reinforced and the valve hole 13a can be surely shut off. Moreover, the valve plug 15 hits the valve seat 13 and compresses the O-ring 16 at this time, and the valve seat 13 follows the movement of the valve plug 15 and swings in the clearance 20a in the flow passage 20 so that the valve hole 13a can be surely shut off.

In FIG. 2, the movement of the valve seat 13 is shown by an arrow. Since the valve seat 13 is oscillated flexibly in the flow passage 20, in spite of the clearance 20a between it and the inner surface of the flow passage 20, fluid leakage between the valve seat 13 and the flow passage 20 is surely shut off by the O-ring 16. The eccentric type rotary valve 10 can allow the fluid to flow again only by opening the valve hole 13a by rotating the valve shaft 12.

In the eccentric type rotary valve 10, the valve plug 15 is supported in the cantilever state, and opening/closing operation of the valve plug 15 might lack accuracy when compared with the case where it is mounted on the valve shaft crossing the flow passage as shown in FIG. 11 or the case where it is supported in the center impeller state as shown in FIG. 12. However, in the eccentric type rotary valve 10, the valve seat 13 moves following the movement of the valve plug 15 and absorbs slight movement of the valve plug 15 so that the valve hole 13a can be surely shut off.

The valve plug 15 is mounted on the one end 12a of the valve shaft 12 in the valve chamber 19 and supported in the cantilever state. In the valve plug 15, as shown in FIG. 5(A), the valve shaft 12 does not block the flow passage 20. Therefore, resistance of the valve shaft 12 against the fluid is decreased and the valve shaft 12 does not prevent flow of the fluid when compared with the case where the valve shaft crosses the flow passage as with the conventional eccentric type rotary valve shown in FIG. 11 (See FIG. 5(B)) or the case where the valve plug 15 is mounted on two valve shafts 12 as shown in FIG. 12. By this, the valve capacity Cv value is increased and the flow rate can be increased. According to theoretical calculation, in the eccentric type rotary valve 10, since the valve plug 15 is supported in the cantilever state and the valve chamber 19 is made in the above-described asymmetrical shape, the Cv value is made larger by 10 to 20% than the conventional eccentric type rotary valve so that control range of the fluid is expanded and the valve performance can be improved.

At inspection or part replacement, since the valve casing is made from one piece in the conventional eccentric type rotary valve as shown in FIGS. 11 and 12, it was not possible to inspect the inside of the valve chasing or to replace the valve plug without removing them from piping. On the other hand, for the eccentric type rotary valve 10, it is possible to inspect the inside of the valve casing 18 by opening the bonnet 17 while it is mounted on the piping or to remove and replace the valve plug 15 together with the valve shaft 12 through the opening of the valve body 11, which makes inside inspection of the valve casing 18 and replacement of the valve plug 15 easy.

Also, for the conventional eccentric type rotary valve, it was necessary to extend the neck portion of the valve casing through which the valve shaft goes in order to reduce influence of temperature when used in a high temperature range (about 0 to 500 degrees centigrade), and special deep hole machining was needed in manufacture of the valve casing. On the other hand, for the eccentric type rotary valve 10, it is only necessary to thicken the vicinity of the through hole of the bonnet 17 through which the valve shaft 12 passes, which eliminates special machining such as deep hole machining but manufacture with a general-purpose machine tool is possible. Also, only by preparing the bonnet 17 with the vicinity of the through hole in various thicknesses, those with low cost can be used according to the temperature range to be used.

In order to see the effect of the eccentric type rotary valve 10, the Cv value against the valve opening degree was measured in comparison with a globe valve (spherical valve) with the same valve-seat diameter. The result is shown in the graph of FIG. 6. Referring to FIG. 6, the eccentric type rotary valve 10 obtained the valve capacity Cv value of 2.5 times of the globe valve when the valve plug 15 of the eccentric type rotary valve 10 is opened at 90 degrees, 2.0 times when opened at 75 degrees and 1.5 times when opened at 60 degrees. Also, the Cv value of the eccentric type rotary valve 10 against the valve angle was measured in comparison with the conventional eccentric type rotary valve shown in FIG. 11. The result is shown in the graph of FIG. 7. Referring to FIG. 7, the eccentric type rotary valve 10 obtained the valve capacity Cv value of about 1.3 times of the conventional eccentric type rotary valve. Because of the increase of the valve capacity Cv value, the eccentric type rotary valve 10 can have the flow-rate regulation (control) range (ratio of the valve capacity Cv value between the maximum and the minimum) as a flow-rate regulating valve of 300:1 or more compared to about 100:1 of the conventional one.

Generally, the type of a regulating valve is chosen (valve sizing) one by one according to the flow-rate condition (range to regulate the flow rate). That is because the valve capacity Cv value (also called as a rated Cv value of the valve) is determined for each valve. Since a valve with a small valve capacity Cv value (valve with a narrow range for flow-rate regulation) can not be used for the condition with a large flow rate (case where the range to regulate the flow rate is large), a valve which can regulate (control) fluid is chosen so that the flow rate is made larger by increasing the valve-seat diameter by 1 size (to a valve with larger valve capacity Cv value).

Since the eccentric type rotary valve 10 has a large valve capacity Cv value and a wide range for flow-rate regulation (control), one unit can handle a problem of the conventional valve type selection (valve sizing) for the case where the valve-seat diameter should be larger by 1 size for the condition with a large flow rate or when the regulation range is wide.

That is, since the eccentric type rotary valve 10 can handle the flow-rate range of 2 to 3 units of the conventional globe valve (spherical valve) and has the valve capacity Cv value of about 1.3 times of the conventional eccentric plug type rotary valve, the flow-rate regulation (control) range is wider and it is not necessary to increase the valve-seat diameter by 1 size. As a result, the valve type selection (valve sizing) can be simplified and selection of the valve type in product handling can be facilitated.

Also, in the eccentric type rotary valve 10, the valve plug 15 is integrated with the valve shaft 12, and the number of components is smaller than that of the conventional eccentric plug type rotary valve. Therefore, the eccentric type rotary valve 10 is realized as a product for which machining/assembly/disassembly is easy, which enables cost reduction.

### EXAMPLE 1

FIG. 8 shows an eccentric type rotary valve according to the Example 1.

In this Example, the valve seat 13 is provided in the valve casing 18 through the bellows 40 in the above basic structure.

When the valve plug 15 arranged eccentrically is rotated, the valve plug 15 urges the valve seat 13. The bellows is expanded/contracted by the urging force. That is, the following performance of the valve plug 15 to the valve seat 13 becomes extremely better and thereby sealing performance is improved. As a result, a flow rate in exact accordance with the opening amount of the valve hole with rotation of the valve plug 15 can be obtained. That is, flow control can be performed with high accuracy.

### EXAMPLE 2

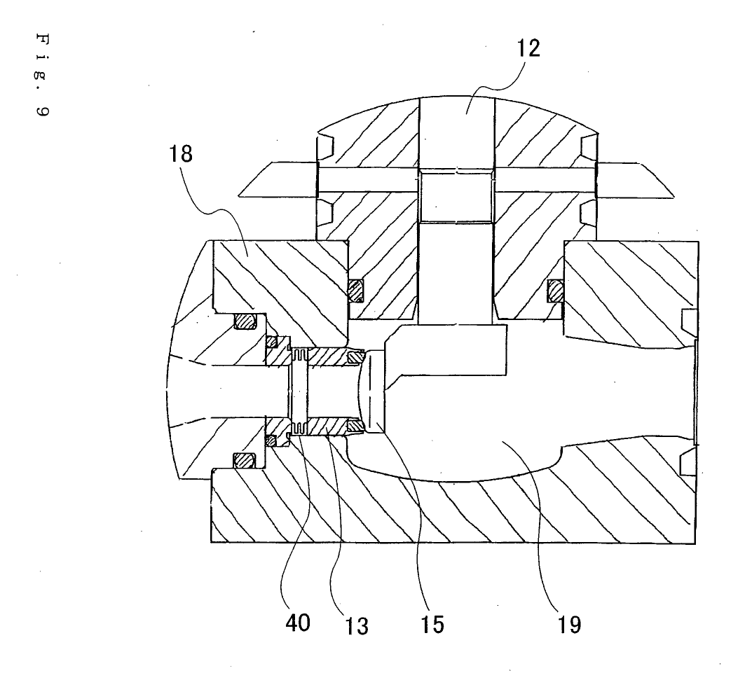

FIG. 9 shows an eccentric type rotary valve according to the Example 2.

In this example, a contact portion 15f in the valve plug 15 with the valve seat 13 in the above basic structure is constituted by a resin. Therefore, the sealing performance between the valve plug 15 and the valve seat 13 is made better, and the accuracy of the flow control can be improved.

### EXAMPLE 3

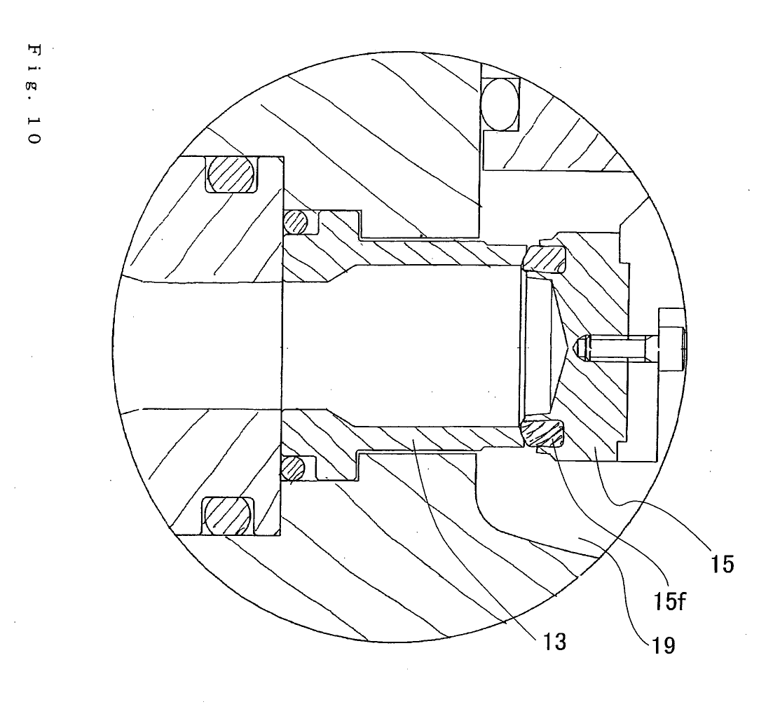

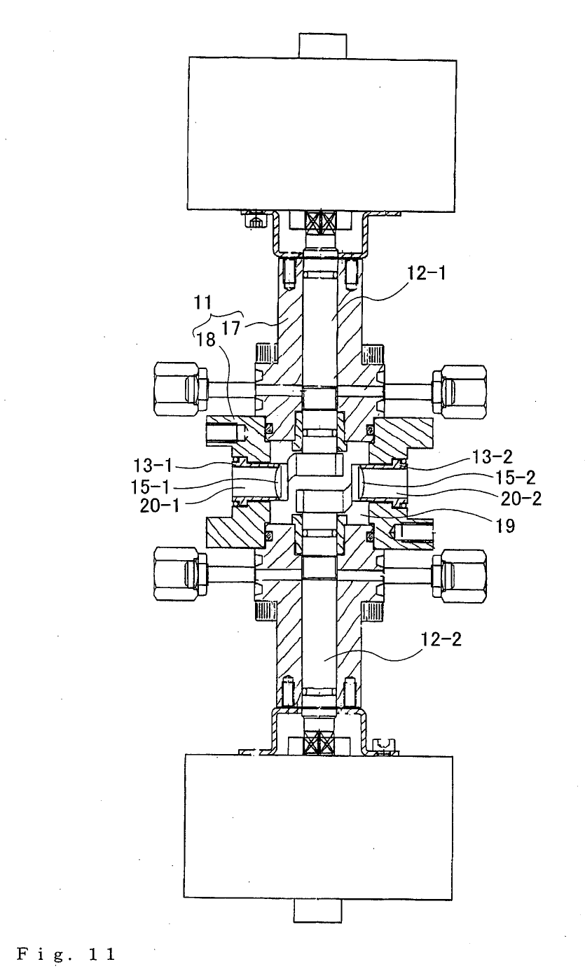

FIG. 10 shows an eccentric type rotary valve according to the Example 3.

In this Example, a pair of valve shafts 12-1 and 12-2 are provided vertically. Valve plugs 15-1 and 15-2 are provided respectively at the valve shafts 12-1 and 12-2.

The valve plug 15-1 is used for opening/closing a flow passage 20-1 by opening/closing with a valve seat 13-1, while a valve plug 15-2 is used for opening/closing a flow passage 20-2 by opening/closing with a valve seat 13-2.

And by providing a flow passage other than the flow passages 20-1 and 20-2 in the state communicating with the valve chamber 19 and the outside, it constitutes a double three-way valve, and this eccentric type rotary valve can be used for a variety of applications.

For example, another flow passage 20-1 may be connected to a chamber and the flow passage 20-2 to a VENT. This is used particularly suitably for the application as a vaporizer.

Also, it is possible to introduce a liquid material of MOCVD through another flow passage, while a gas is introduced through the flow passage 20-1 so that a gas including the liquid material is made to flow out of the flow passage 20-2. In this case, the valve chamber 19 plays a role as a mixing chamber. That is, it has an application as a mixer. Also, it can be used as a gas refining device.

It is needless to say that a plurality of flow passages other than the flow passages 20-1 and 20-2 may be provided.

1. An eccentric type rotary valve having a valve body, a valve shaft, a valve seat and a valve plug, in which said valve body has a valve chamber inside and a flow passage passing through this valve chamber, said valve shaft extends in the direction crossing said flow passage and penetrates the wall surface of said valve body and its one end is arranged in said valve chamber, said valve seat has a valve hole and is provided at an inlet or an outlet of the valve chamber of said flow passage, and said valve plug is mounted to one end of said valve shaft in the cantilever state and provided in said valve chamber capable of opening/closing said valve hole by rotation of said valve shaft, characterized in that:
said valve seat is provided through a bellows.

2. An eccentric type rotary valve having a valve body, a valve shaft, a valve seat and a valve plug, in which said valve body has a valve chamber inside and a flow passage passing through this valve chamber, said valve shaft extends in the direction crossing said flow passage and penetrates the wall surface of said valve body and its one end is arranged in said valve chamber, said valve seat has a valve hole and is provided at an inlet or an outlet of the valve chamber of said flow passage, and said valve plug is mounted to one end of said valve shaft in the cantilever state and provided in said valve chamber capable of opening/closing said valve hole by rotation of said valve shaft, characterized in that:
a portion of said valve plug brought into contact with said valve seat is constituted by a resin.

3. An eccentric type rotary valve having a valve body, a pair of valve shafts, a pair of valve seats and a valve plug provided at each of the valve shafts, characterized in that:
said valve body has a valve chamber inside and a plurality of flow passages communicating from this valve chamber to the outside;
each of said pair of valve shafts extends in the direction crossing said flow passage and penetrates the wall surface of said valve body, respectively, and its one end is arranged in said valve chamber;
each of said pair of valve seats has a valve hole and is provided on the valve chamber side of said plurality of flow passages; and
said valve plug is mounted at one end of said valve shaft in the cantilever state and provided in said valve chamber capable of opening/closing said valve hole by rotation of said valve shaft.
